(19) United States
(12) Patent Application Publication
(10) Pub. No.: US 2012/0000124 A1
(43) Pub. Date: Jan. 5, 2012

(54) VERSATILE, MODULAR PLANT SUPPORT SYSTEM, KIT AND METHOD

(76) Inventor: John G. Posa, Ann Arbor, MI (US)

(21) Appl. No.: 13/173,818

(22) Filed: Jun. 30, 2011

Related U.S. Application Data
(60) Provisional application No. 61/360,036, filed on Jun. 30, 2010.

(51) Int. Cl. A01G 17/06; A01G 1/00; A01G 17/14

(52) U.S. Cl. 47/45; 47/47; 47/58.1 R

(57) ABSTRACT

A system, kit and method are disclosed to support a variety of plants, including tomato plants, flowers such as peonies and roses, small trees and bushes. A rod having a cross-sectional geometry with upper and lower ends defining a length includes a socket configured to receive the lower end of another one of the rods, enabling a plurality of the rods to be stacked. A plurality of retainer components are spaced apart along the length of the rod, each retainer component including one or more capture devices, each capture device being configured to retain a portion of a flexible member. The lower end of one or more of the rods may then be placed into the ground proximate to a live plant with the flexible member positioned around at least a portion of the plant and attached at one or more of the capture devices to support the plant.

### REFERENCE TO RELATED APPLICATION

This application claims priority from U.S. Provisional Patent Application Ser. No. 61/360,036, filed Jun. 30, 2010, the entire content of which is incorporated herein by reference.

### FIELD OF THE INVENTION

This invention relates generally to gardening and, in particular, to a plant support system, kit and method including various components that may be reconfigured to support a variety of growing plants including vegetable plants, flowers and small trees.

### BACKGROUND OF THE INVENTION

Many different kinds of plants benefit from support structures while they grow. Tomato plants, for instance, produce heavy fruit which may contact the ground or damage the plant if not properly supported. However, the typical “tomato cage” has numerous deficiencies. For one, being made of welded steel wire, it is inflexible, and suits only plants of a certain size. It becomes rusty and bent up after multiple seasons of use, and although most such articles may be nested within one another, they are bulky when stored.

Over the years, an enormous number of plant stakes and supports have been developed and patented in an attempt to achieve versatility, compact storage, or particular growth requirements. Newer, foldable cage designs, which use hinged or sliding couplings instead of welding, maybe stored in a flat position but they are often very difficult to use.

### SUMMARY OF THE INVENTION

This invention resides in a system, kit and method that may be used to support a variety of plants, including tomato plants, flowers such as peonies and roses, small trees and bushes. A versatile, modular plant support according to the invention includes a rod having a cross-sectional geometry with upper and lower ends defining a length. The upper end of the rod includes a socket configured to receive the lower end of another one of the rods, enabling a plurality of the rods to be coupled together on an end-to-end basis. A plurality of retainer components are spaced apart along the length of the rod, each retainer component including one or more capture devices, each capture device being configured to retain a portion of a flexible member. The lower end of one or more of the rods may then be placed into the ground proximate to a live plant with the flexible member positioned around at least a portion of the plant and attached at one or more of the capture devices to support the plant.

A plant support kit provided in accordance with the invention includes a plurality of plant supports and a length of flexible member configured for attachment to the capture devices of the supports. A method of supporting a growing plant, comprising the step of providing a plurality of plant supports and a length of flexible member. One or more of the rods are placed into the ground proximate to a growing plant to be supported, and the flexible member is connected to one or more of the capture devices and around a portion of the growing plant. One plant support system according to the invention comprises a length of strap having a plurality of spaced-apart perforations. At least one elongated member has a lower end adapted for ground penetration and an upper end configured to interconnect with the lower end of an additional, identical elongated member, and a plurality of posts protruding from the member, each post being configured for engagement with the perforations on the strap.

### BRIEF DESCRIPTION OF THE DRAWINGS

FIG. 1 depicts a preferred embodiment of the invention including a rod defining a length in the range of 30 to 40 inches;

FIG. 2 illustrates the preferred retainer component with capture devices that retain a flexible member in the form of a cord or string;

FIG. 3 shows how capture devices may include living hinges;

FIG. 4 shows a configuration with posts to receive the holes of a perforated strap;

FIG. 5 shows posts with bulbous ends also suited to perforated flexible members;

FIG. 6 shows how a plurality of capture devices may be used, such as three such devices peripherally spaced apart around the retainer component;

FIG. 7 depicts how the capture devices may be vertically stacked on each retainer component;

FIG. 8 is a basic configuration with three supports and a sufficient length of flexible member to support a rose bush, a flower such as a peony, or a young tomato plant;

FIG. 9 shows how, when a plant grows, the rods may be stacked using the sockets to create a higher structure;

FIG. 10 illustrates an advantage of the system in that “grow-through” configurations are easily accommodated;

FIG. 11 shows two supports, one on each side of a sapling

FIGS. 12 and 13 illustrate how the rods may easily be tilted inwardly or outwardly for peas, beans, and rounder bushes;

FIG. 14 shows how a trellis may be built with the invention;

FIG. 15 depicts a support against a wall or fence;

FIG. 16 shows how a fence itself may be built with the system;

FIG. 17 illustrates the use of alternative cross-sectional geometries such as V-shapes;

FIG. 18 depicts an embodiment with three retainer components, each including an offset socket, capture devices;

FIG. 19 shows a foot pad;

FIG. 20 is a top-down view showing the preferred use of stabilizing fins in conjunction with a foot pad for planting;

FIG. 21 illustrates two of the supports of FIG. 18 in a nested configuration;

FIG. 22 shows some dimensions applicable to any of the embodiments disclosed herein;

FIG. 23 shows two of the supports of FIG. 22 in a nested configuration;

FIG. 24 illustrates the support of FIG. 22 with a foot pad and stabilizing fins;

FIG. 25 shows a retainer component according to the invention that may slide up and down a rod;

FIG. 26 illustrates a further alternative embodiment wherein the retainer components are clipped or otherwise attached to existing rods such as bamboo or plastic poles;

FIG. 27 shows four poles with flexible members in the form of straps; and

FIG. 28 illustrates another version with string-receiving slits.

### DETAILED DESCRIPTION OF THE INVENTION

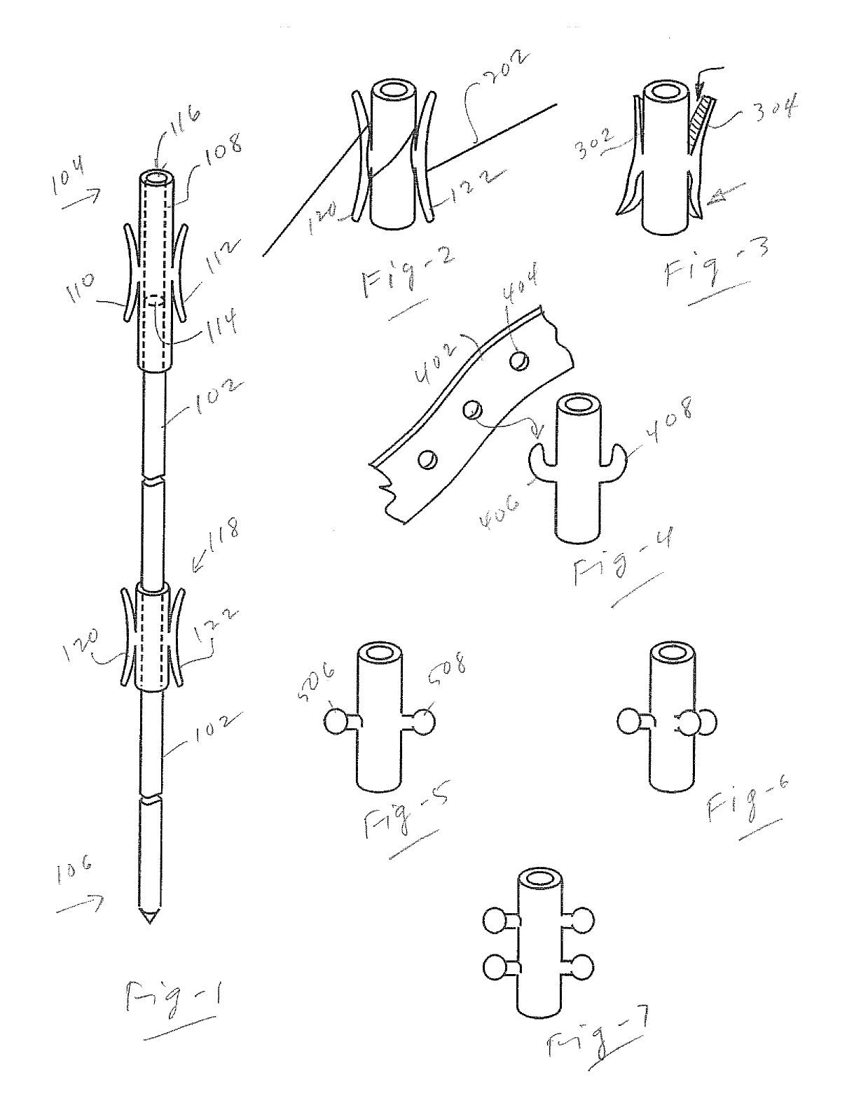

This invention resides in a system, kit and method that may be used to support a variety of plants, including tomato plants, flowers such as peonies and roses, small trees and bushes. The preferred embodiment, shown in FIG. 1, includes a rod 102 having an upper end 104 and a lower end 106 defining a length in the range of 30 to 40 inches, more preferably in the range of 30 to 36 inches. The upper end of the rod includes a socket 116 configured to receive the lower end of another one of the rods, enabling a plurality of the rods to be coupled together on an end-to-end basis as shown in subsequent drawings.

A plurality of retainer components are spaced apart along the length of the rod. In the preferred embodiment of FIG. 1, the upper retainer component 108 includes the socket 116. At least one additional retainer component 118 is provided between the two ends of the rod. Each retainer component 108, 118 includes one or more capture devices 110, 112, 120, 122, each capture device being configured to retain a portion of a flexible member (not shown) such as a string, cord, or strap. With the support of FIG. 1, of one or more of the rods may be placed into the ground proximate to a plant with the member positioned around at least a portion of the plant and attached at one or more of the capture devices to support the plant. FIGS. 8-16 shown different configurations described below.

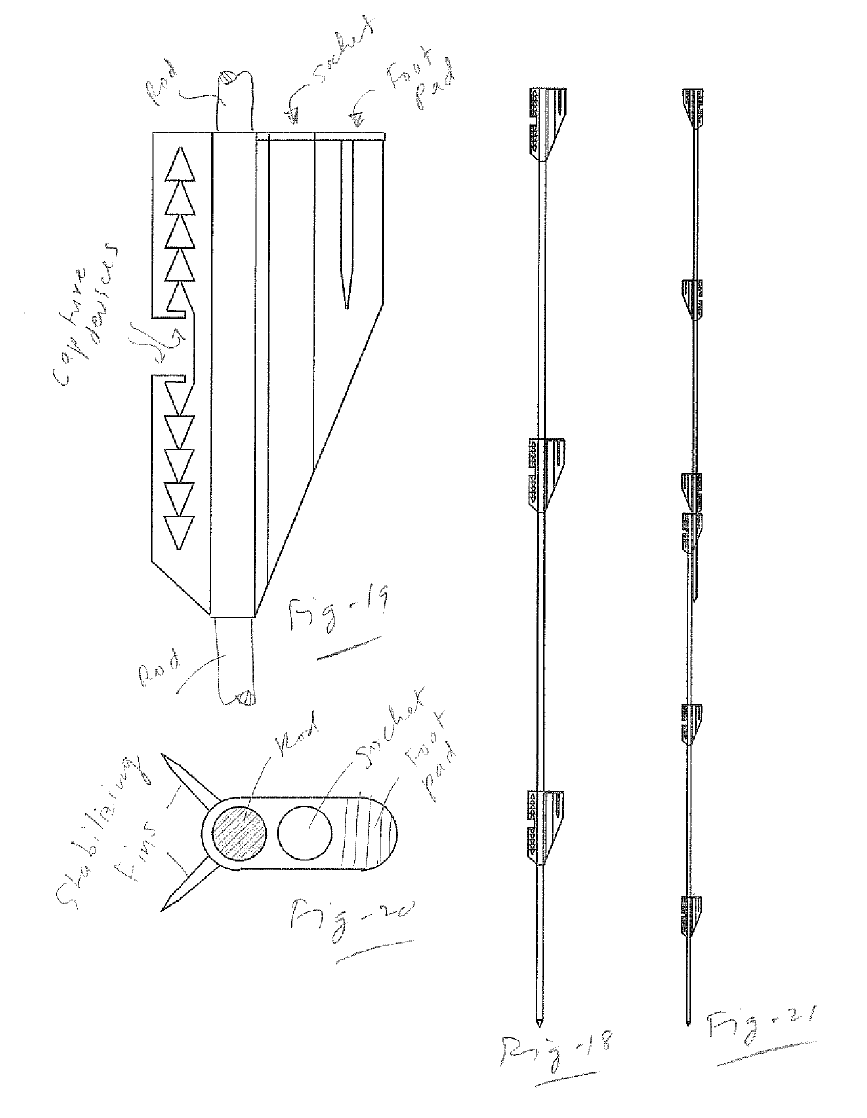

In the preferred embodiment, the retainer components are plastic and over-molded onto a solid, cylindrical fiberglass rob having a diameter of ¼″. However, in alternative embodiments the rod may be a hollow tube and may be made of other materials such as metal (steel, aluminum), plastic or wood. Depending upon the rod material, other diameters up to ½″ may be used as well as other cross-sectional geometries such as V-shapes, as shown in FIG. 17. If the rod is plastic, the rod, retainer components and socket may all be integrally molded.

FIG. 2 illustrates the preferred retainer component with capture devices 120, 122 which retain a flexible member in the form of a cord or string 202. In this case the capture devices include tapered slits that capture the flexible member as it slides into the slit. As an alternative, the capture devices may include living hinges allow a user to open (304) the gap from a closed position (302) as shown in FIG. 3.

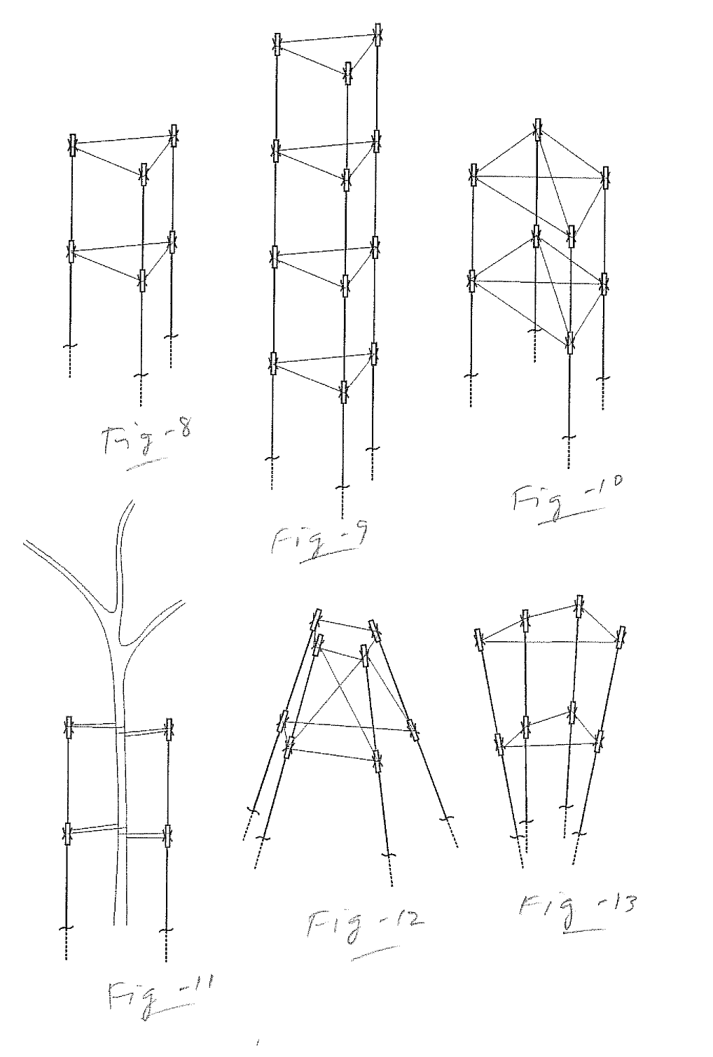

FIG. 4 shows a configuration with posts 406, 408 to receive the holes 404 of a perforated strap 402 according to the invention. FIG. 5 shows posts 508, 508 with bulbous ends also suited to perforated flexible members. Each retainer component may have one or more capture device, and the capture devices on each retainer component may be the same or different. In all embodiments, a pair of opposing capture devices may be used, as shown in FIG. 5, or more devices such as three may be peripherally spaced apart around the retainer component as shown in FIG. 6. In all embodiments, the capture devices may be vertically stacked on each retainer component as shown in FIG. 7.

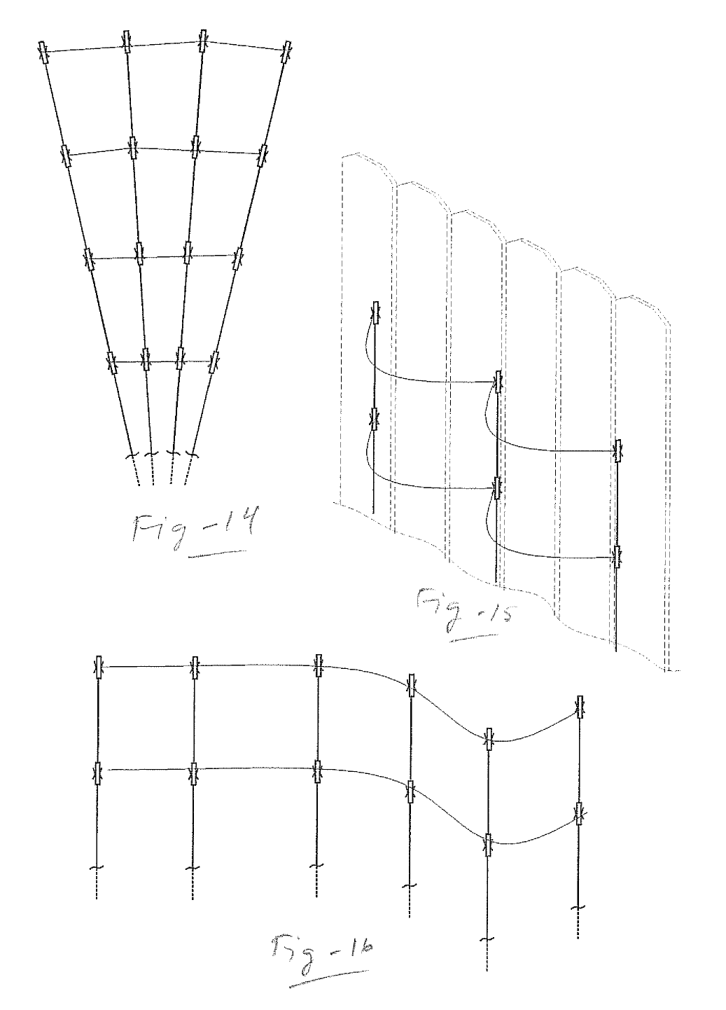

FIGS. 8-16 depict the versatility of the system. FIG. 8 is a basic configuration with three supports and a sufficient length of flexible member to support a rose bush, a flower such as a peony, or a young tomato plant. In any case, when the plant grows, the rods may be stacked using the sockets to create a higher structure, as shown in FIG. 9.

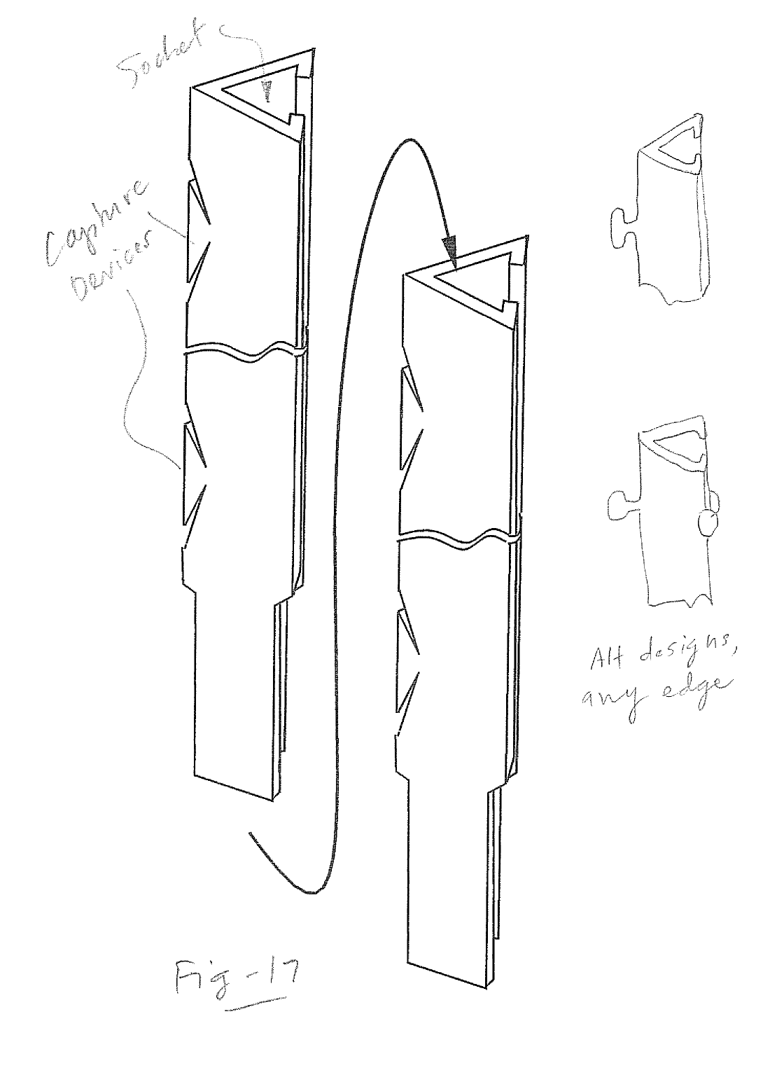

An advantage of the system is that “grow-through” configurations are easily accommodated, as shown in FIG. 10. FIG. 11 shows two supports, one on each side of a sapling. FIGS. 12, 13 illustrate how the rods may easily be tilted inwardly or outwardly for peas, beans, and rounder bushes. FIG. 14 shows how a trellis may be built. FIG. 15 depicts a support against a wall or fence. FIG. 16 shows how a fence itself may be built with the system.

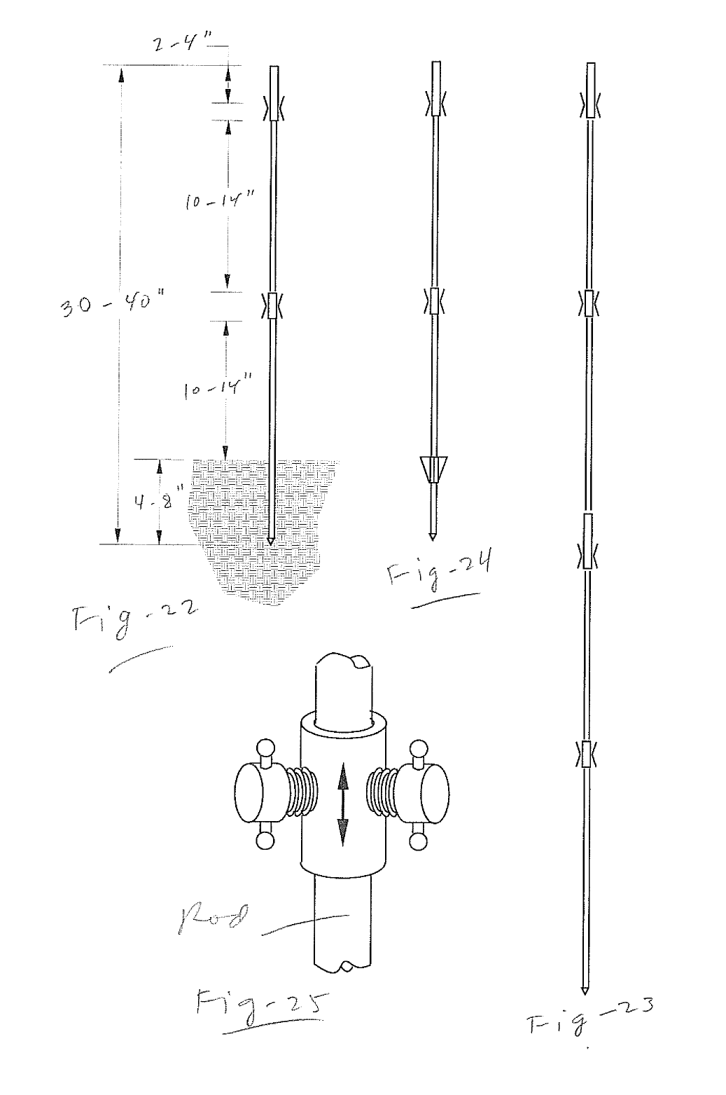

FIG. 18 depicts an embodiment with three retainer components, each including an offset socket, capture devices, and foot pad (FIG. 19). FIG. 20 is a top-down view showing the preferred use of stabilizing fins in conjunction with a foot pad for planting. FIG. 21 illustrates two of the supports of FIG. 18 in a nested configuration.

FIG. 22 shows some dimensions applicable to any of the embodiments disclosed herein. The socket depth is preferably in the range of 2-4″, depending upon the diameter and/or shape of the rod or support material used. FIG. 23 shows two of the supports of FIG. 22 in a nested configuration. FIG. 24 illustrates the support of FIG. 22 with a foot pad and stabilizing fins.

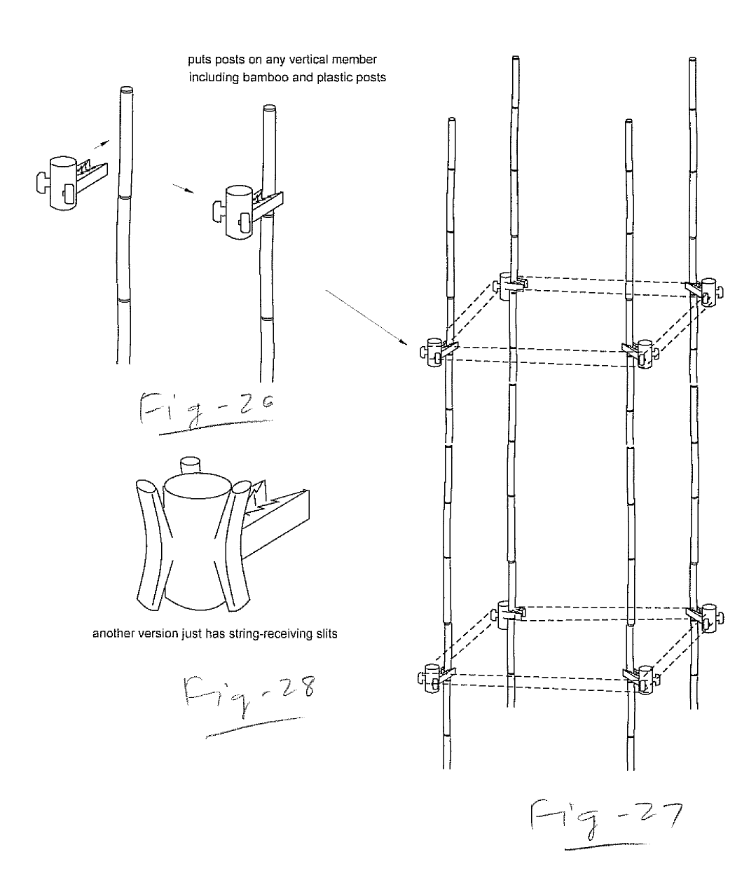

FIG. 25 shows a retainer component according to the invention that may slide up and down a rod. In this case the capture devices double as tightening mechanisms though this is not necessary in that they may be separate or a rod with serrations or other surfaces may be used for a frictional engagement.

FIG. 26 illustrates a further alternative embodiment wherein the retainer components are clipped or otherwise attached to existing rods such as bamboo or plastic poles. FIG. 27 shows four poles with flexible members in the form of straps, and FIG. 28 illustrates another version with string-receiving slits.

In all embodiments, all components including the supports and flexible members are green in color to blend in with vegetation. While a kit may include specialized perforated or non-perforated straps or re-useable string or cord, the preferred embodiments use a green-colored twine such as jute which may be discarded, recycled and/or composted along with certain plants like tomatoes at the end of the season. In this way a used need only save the supports for next year, adding new twine as needed.

I claim:

1. A versatile, modular plant support, comprising:
a rod having a cross-sectional geometry with upper and lower ends defining a length;
the upper end of the rod including a socket configured to receive the lower end of another one of the rods, enabling a plurality of the rods to be coupled together on an end-to-end basis;
a plurality of retainer components spaced apart along the length of the rod, each retainer component including one or more capture devices, each capture device being configured to retain a portion of a flexible member; and
whereby the lower end of one or more of the rods may be placed into the ground proximate to a live plant with the member positioned around at least a portion of the plant and attached at one or more of the capture devices to support the plant.

2. The plant support of claim 1, wherein the socket is integrally formed with at least one of the capture devices.

3. The plant support of claim 1, wherein the rod is fiberglass.

4. The plant support of claim 1, wherein the rod is plastic.

5. The plant support of claim 1, wherein the rod is metal.

6. The plant support of claim 1, wherein the rod is wooden.

7. The plant support of claim 1, wherein the socket and retainer components are overmolded onto the rod.

8. The plant support of claim 1, wherein the rod, socket and retainer components are integrally molded plastic.

9. The plant support of claim 1, including capture devices with a tapered slit to receive a portion of a flexible member.

10. The plant support of claim 1, including capture devices with a post around which a portion of the flexible member may be wound.

11. The plant support of claim 1, including capture devices with a jaw opened with a living hinge to receive a portion of a flexible member.

12. The plant support of claim 1, including retainer components with a plurality of capture devices circumferentially spaced apart around the component.

13. The plant support of claim 1, including retainer components with a plurality of the same or different types of capture devices.

14. The plant support of claim 1, wherein the socket is axially aligned with the rod.

15. The plant support of claim 1, wherein the socket is axially offset with the rod.

16. The plant support of claim 1, further including a foot hold to assist with placing the lower end of the rod into the ground.

17. The plant support of claim 1, wherein the rod has a circular cross-section.

18. The plant support of claim 1, wherein the rod has a circular cross-section with a diameter of ¼ to ½ inch.

19. The plant support of claim 1, including a total of two or three retainer components spaced apart along the rod, including one at the upper end which includes the socket.

20. The plant support of claim 1, wherein the rod, the retainer components, or both are green in color.

21. A plant support kit comprising the following, packaged as a unit:
a plurality of the plant supports of claim 1; and
a length of flexible member configured for attachment to the capture devices of the supports.

22. The plant support kit of claim 20, including three plant supports and 12 to 24 feet of the flexible member.

23. The plant support kit of claim 20, including four plant supports and 16 to 30 feet of the flexible member.

24. The plant support kit of claim 20, wherein any or all of the rod, the retainer components and the flexible member are green in color.

25. A method of supporting a growing plant, comprising the steps of:
providing a plurality of the plant supports of claim 1 and a length of flexible member;
placing one or more of the rods into the ground proximate to a growing plant to be supported; and
connecting the flexible member to one or more of the capture devices and around a portion of the growing plant.

26. The method of claim 25, further including the step of cutting the flexible member as necessary to accommodate the growing plant.

27. The method of claim 25, further including the steps of:
inserting one or more additional rods into the sockets of previously placed rods; and
adding flexible member to the capture devices and around the plant as it grows.

28. The method of claim 25, including the steps of:
placing three or more of the rods in the ground around a growing plant; and
connecting the flexible member to all three of the members to form a triangular plant support.

29. The method of claim 25, including the steps of:
placing four or more of the rods in the ground around a growing plant; and
connecting the flexible member to adjacent rods and across to non-adjacent rods to form a grow-through type plant support.

30. The method of claim 25, including the steps of:
placing three or more lower rods in the ground around a growing plant;
inserting one or more upper rods into the sockets of the rods in the ground; and
connecting the flexible member between the upper and lower elongated members to form a cage configuration.

31. The plant support of claim 1, wherein the retainer components are separate from the rod and coupled thereto.

32. The plant support of claim 1, wherein the retainer components are separate from the rod and include a bore to receive the rod in sliding engagement.

33. The plant support of claim 1, wherein the flexible member is a thin strap with a plurality of round, spaced-apart perforations.

34. The plant support of claim 1, wherein the flexible member is a thin strap with a plurality of spaced-apart rectangular perforations.

35. The plant support of claim 1, wherein the flexible member is a thin strap with a plurality of spaced-apart slits.

36. A modular plant support system, comprising:
a length of flexible material;
an elongate member having an upper section, a lower section, a length and a cross section;
an upper component attached to the upper section of the member, the upper component including a structure to capture the flexible material in a region along its length and a bore slightly larger than the cross section of the member to receive the lower section of another one of the elongate members in slip-fit engagement; and
a lower component attached to the lower section of the member, the lower component including a foot plate extending outwardly from the member.

37. The modular plant support system of claim 36, further including one or more intermediate components attached to the member between the upper and lower components, each intermediate component including a structure to capture the flexible material in a region along its length.

38. The modular plant support system of claim 36, wherein the elongate member is a cylindrical rod having a circular cross section.

39. The modular plant support system of claim 36, wherein the upper and lower components are substantially identical whereby the upper component also includes a foot plate and the lower component also includes a bore and a structure to capture the flexible material in a region along its length.

40. A support system, comprising:
a length of strap having a plurality of spaced-apart perforations;
at least one elongated member having a lower end adapted for ground penetration and an upper end configured to interconnect with the lower end of an additional, identical elongated member; and
a plurality of posts protruding from the member, each post being configured for engagement with the perforations on the strap.

41. The support system of claim 40, wherein at least some of the posts are disposed on a separate component coupled to the elongated member.

42. The support system of claim 40, wherein at least some of the posts are disposed on a separate collar having a bore to receive the elongated member.

43. The support system of claim 40, wherein at least some of the posts are vertically spaced apart.

44. The support system of claim 40, wherein the posts terminate in a T shape.

45. The support system of claim 40, wherein the posts terminate in a ball shape.

46. The support system of claim 40, wherein the posts terminate in a transverse button shape.

47. The support system of claim 40, wherein the elongated member and posts are integrally formed with molded plastic material.

48. The support system of claim 40, wherein:
the elongated member is extruded to have a consistent and uniform cross section; and
the posts are on a separate component coupled to the elongated member.

49. The support system of claim 40, wherein:
the elongated member is made of metal; and
the posts are on a separate, molded plastic component coupled to the elongated member.

50. The support system of claim 40, wherein the perforations on the strap are round.

51. The support system of claim 40, wherein the perforations on the strap are rectangular.

52. The support system of claim 40, wherein the perforations on the strap are slits.

53. The support system of claim 40, wherein the elongated member and strap are green in color.

54. The support system of claim 40, wherein the upper end of the elongated member includes a socket to receive the lower end of an additional elongated member.

55. The support system of claim 40, wherein:
the posts are disposed on a separate component coupled to the upper end of the elongated member; and
wherein the separate component includes a socket to receive the lower end of an additional elongated member.

56. A kit for supporting flowers and plants while growing, the kit comprising:
a length of strap having a plurality of spaced-apart perforations;
a plurality of elongated members, each having a lower end adapted for ground penetration and an upper end configured to interconnect with the lower end of another one of the elongated members;
a plurality of posts protruding from each member, each post being configured for engagement with the perforations on the strap; and
whereby the lower ends of the elongated members may be placed into soil or interconnected to the upper ends of other elongated members, with the strap being connected to the posts to form various support configurations.

57. A method of supporting a plant, comprising the steps of:
providing a flexible strap having a plurality of spaced-apart perforations and a plurality of elongated members, each member having a lower end adapted for ground penetration, an upper end configured for interconnection with the lower end of another one of the elongated members, and a plurality of protruding posts configured for engagement with the perforations on the strap;
placing one or more of the elongated members into the ground proximate to a plant to be supported; and
connecting the strap to one or more of the posts on the elongated member and around a portion of the plant to be supported.

58. The method of claim 57, including the steps of:
placing three or more of the elongated members in the ground around a plant; and
connecting the strap to all three of the elongated members to form a triangular plant support.

59. The method of claim 57, including the steps of:
placing four or more of the elongated members in the ground around a growing plant; and
connecting the strap to adjacent elongated members and across to non-adjacent elongated members to form a grow-through type plant support.

60. The method of claim 57, including the steps of:
placing three or more lower elongated members in the ground around a growing plant;
interconnecting upper elongated members to each of the lower elongated members; and
connecting the strap between the upper and lower elongated members to form a cage configuration.

61. The method of claim 57, including the steps of:
placing two or more lower elongated members in the ground behind a growing plant;
interconnecting upper elongated members to each of the lower elongated members; and
connecting the strap between the upper and lower elongated members to form a trellis configuration.

62. The method of claim 57, including the step of cutting the strap if necessary to connect the strap to one or more of the posts on the elongated member.
